(19) United States
(12) Patent Application Publication
(10) Pub. No.: US 2002/0152969 A1
(43) Pub. Date: Oct. 24, 2002

(54) Pet enclosure

(76) Inventors: Alex M. Grigsby, Fremont, CA (US); Mae Grigsby, Fremont, CA (US)

Correspondence Address: Harris Zimmerman, Law Offices of Harris Zimmerman, 1330 Broadway, Suite 710, Oakland, CA, 94612-2506, US

(21) Appl. No.: 09/839,518

(22) Filed: Apr. 23, 2001

(51) Int. Cl. A01K 1/02; A01K 1/03; F24F 7/00; F24F 7/007

(52) U.S. Cl. 119/500

(57) ABSTRACT

A pet enclosure for dogs and cats which is an attractive piece of furniture. The pet enclosure includes a decorative exterior cabinet with a padded lower portion for pet comfort. An upper ventilation structure includes a motion activated electric motor and activated carbon filters to provide ventilation for the pet while eliminating odors and airborne pet dander from exiting into the room. The pet enclosure includes a light and a camera connectable to the Internet for viewing pet activity remotely from a computer. Various upgrade packages adapt the features of the pet enclosure, such as the ventilation, lighting, and Internet camera to other pet enclosures.

### BACKGROUND OF THE INVENTION

1. Field of Invention

The present invention relates to beds and indoor enclosures for pets such as dogs and cats.

2. Description of Related Art

Pet Enclosures in General

Pet beds and pet enclosures are for providing a resting place for pets during the day and a comfortable place to sleep at night. One such enclosure is disclosed in U.S. Pat. No. 5,282,439 issued to Robertson, Sr. for bedding and also for whelping. A removable curved access opening at the front of the four-sided structure allows easy entrance and exit. A removable base doubles as a lid and along with the front panel to acts as a casket when the pet passes away.

Unsightly

One shortcoming of the prior art pet enclosures is that they are somewhat unsightly, not fitting in well with existing furniture in a house or apartment. Attempts have been made to provide pet beds and enclosures which are more aesthetically appealing. One such attempt is a combined bed and housing unit in U.S. Pat. No. Des. 288,970 issued to Runion. The housing unit includes a decorative cabinet having double front doors. A side opening allows entrance and exit of the pet. A pair of upper panels open to ventilate and permit cleaning of the housing unit.

Another such attempt to provide pet beds and enclosures which are more aesthetically appealing is disclosed in U.S. Pat. Nos. 3,618,568 and 3,797,461 both issued to Breeden. The pet houses disclosed, one being a round version and the other being a rectangular version, are designed as an attractive piece of furniture. The round version includes a circular floor panel which supports an upstanding curved wall and a circular top panel. A door is hingedly connected to the wall and pivots radially outwardly and downwardly to double as an entrance ramp for the pet. A series of screened vents are disposed adjacent an upper edge of the wall to permit the circulation of air through the pet house. The pet house is supported on four legs attached to the bottom panel. A circular pad is disposed within the pet enclosure for comfortable resting and sleeping.

The rectangular version of the pet house includes a rectangular floor panel which supports a pair of upstanding rectangular side walls, a pair of upstanding rectangular end walls, and a rectangular top panel. A door is hingedly connected to one side wall at the top panel and pivots laterally outwardly and downwardly to double as an entrance ramp for the pet. The pet house further includes a drawer which pulls out through a large opening in the end wall opposite the door. The drawer serves as a potty for the occupant with the opposite end under the door serving as a sleeping area. A screen covers a ventilation opening through one side wall adjacent the drawer.

Pet Odors

Another shortcoming of the prior art pet enclosures is that they emit pet odors which foul the smell of the house or apartment. Attempts to control pet odor include drawers or trays for the pet to relieve itself which may contain odor reducing litter. One such attempt is the rectangular version of the pet house disclosed in the Breeden wherein the pull-out drawer and the ventilation opening may control odors to a certain degree.

Another such attempt to control pet odors is disclosed in U.S. Pat. No. 5,184,568 issued to Healey. The housing structure for cats includes a lower portion of the housing structure is box-like having an open front into which a litter tray slides. A pair of flexible flaps cover the front opening to minimize exiting odors but allow the cat to freely come and go. The tray includes a support for a spray can of deodorizer. An upper portion of the housing structure includes an upright rear wall. A cushion is horizontally disposed above the lower portion along with a cylindrical cushion with attached tethered ball.

A more aggressive approach to controlling pet odors is the forced ventilation disclosed in U.S. Pat. No. 5,148,768 issued to Hinton. The pet house disclosed in the document includes a rectangular floor panel which supports a pair of upstanding rectangular side walls, a pair of upstanding rectangular end walls, and a rectangular top panel. A front opening in one end wall allows the pet to enter and exit the pet house. A pair of pull-out drawers extend through one side wall which laterally pull out. One of the drawers can be filled with blankets and the other with kitty litter. Various tethered cat toys are attached to the top of the opposite long side. An electric fan may be mounted to the top of the structure opposite the front opening for drawing air through the front opening and through a plurality of vent openings through the end wall opposite the front opening. The purpose of the electric fan is for keeping the occupant pet cool rather than odor elimination.

Allergies

Pet dander and dust is known to cause allergic reactions in people such as a stuffy nose and red eyes. While applicants are aware of pet enclosures having vents, and the above mentioned forced ventilation of Hinton, they are aware of no pet enclosures which provide filtration of the air exiting the pet enclosure to remove pet dander and dust.

Fleas and Ticks

Fleas and ticks are frequently brought into pet beds and pet enclosures by the pet from outside the house or apartment. Applicants are, however, not aware of any pet enclosures which are designed to aid in locating and repelling fleas and ticks.

Improved Pet Enclosure

There is a need for a pet enclosure that is aesthetically pleasing, which fits in with the style of furniture within the house or apartment while providing additional features such as the elimination of pet odors and airborne particulates causing allergies, and while providing flea and tick detection and repelling.

### SUMMARY OF INVENTION

1. Advantages of the Invention

One of the advantages of the present invention is that it provides an enclosure for pets which fits in with and compliments the existing furniture in a house or apartment.

A further advantage of the present invention is its filtering ventilation assembly which reduces pet odor.

Another advantage of the present invention is its adaptability to virtually any style of furniture by providing a cabinet of the appropriate styling.

A still further advantage of the present invention is its filtering ventilation assembly which reduces human allergies and is healthier for the pet by reducing airborne pet dander.

Yet another advantage of the present invention is its ability to monitor the pet by camera over the Internet.

These and other advantages of the present invention may be realized by reference to the remaining portions of the specification, claims, and abstract.

2. Brief Description of the Invention

The present invention comprises an enclosure for housing a pet. The enclosure comprises a cabinet having a bottom panel such as a base, and at least one upstanding wall to define a generally circumferentially enclosed sleeping chamber of sufficient size to contain the pet. The upstanding wall has an entrance opening, preferably disposed at the front of the cabinet, of sufficient size to allow the pet to enter and exit the sleeping chamber. The enclosure preferably includes a top panel or a top wherein the upstanding wall interconnects the top and bottom panels. The cabinet is preferably of generally rectangular configuration wherein the top and bottom panels are of generally rectangular shape, being interconnected by generally rectangular front and rear walls, and by a pair of generally rectangular side walls. The cabinet is preferably made of wood or plastic in a decorative style to generally match the style of other furniture with which it will be used. The enclosure can also be built into such other furniture.

The enclosure preferably includes respective left and right double doors which comprise respective inner and outer panels which are hingedly connected together using respective pairs of hinges. The outer panels are hingedly connected to the front wall laterally adjacent the entrance opening using respective pairs of hinges. The doors allow selective covering of the entrance opening at the front of the cabinet. The doors can also be used to deflect drafts away from the pet within the enclosure. An optional screen or grate is securable to cover the entrance opening with the doors open to secure the pet within the enclosure while allowing the pet proper ventilation.

The enclosure preferably includes a filtering ventilation assembly which comprises an electric fan and at least one filter. The fan and the filter are operatively connected to the cabinet so as to draw airborne particulate laden interior air from within the sleeping chamber through the filter and out to ambient air as filtered air. The filter removes the airborne particulates from the particulate laden air. The filter can include activated carbon to remove odors from the interior air. The electric fan is automatically activated by a motion detector when the pet enters and occupies the sleeping chamber. An on/off switch activates and deactivates the filtering ventilation assembly.

A pad assembly preferably fits within a lower portion of the cabinet. The pad assembly may include a lower pad which rests on the bottom panel and at least one upstanding pad which extends for at least a portion of the outside perimeter of the lower pad. The upstanding pad is of such a height so as to closely fit below the ventilation duct and is also of a similar width so as to be generally flush therewith. When the cabinet is of generally rectangular configuration, the lower pad is generally rectangular, and the upstanding pad comprises a pair of opposed side pads and a rear pad, all being of generally rectangular shape.

A plastic sheet liner of a light color is preferably disposable within at least a lower portion of the cabinet closely adjacent the upstanding wall or walls to highlight fleas and ticks and to provide easy cleaning. An insect repellant such as one or more cedar boards is also disposable within the cabinet to repel fleas and ticks.

The enclosure preferably includes a camera connectable within the cabinet. The camera is operatively connectable to the Internet for transmitting video images to a remote monitoring location.

The above description sets forth, rather broadly, the more important features of the present invention so that the detailed description of the preferred embodiment that follows may be better understood and contributions of the present invention to the art may be better appreciated. There are, of course, additional features of the invention that will be described below and will form the subject matter of claims. In this respect, before explaining at least one preferred embodiment of the invention in detail it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

Preferred embodiments of the present invention are shown in the accompanying drawings wherein:

FIG. 1 is substantially a left front perspective view of a pet enclosure according to the present invention of the type having a top panel, and a pair of front double doors, which are shown in an open position to show the cushioned interior of the pet enclosure;

FIG. 2 is substantially a right rear perspective view of the pet enclosure showing the rear ventilation opening, the motion detector switch, and the interior light switch;

FIG. 3 is substantially a lateral vertical sectional view taken on line 3-3 of FIG. 1 showing the interior of the pet enclosure and the flow of air;

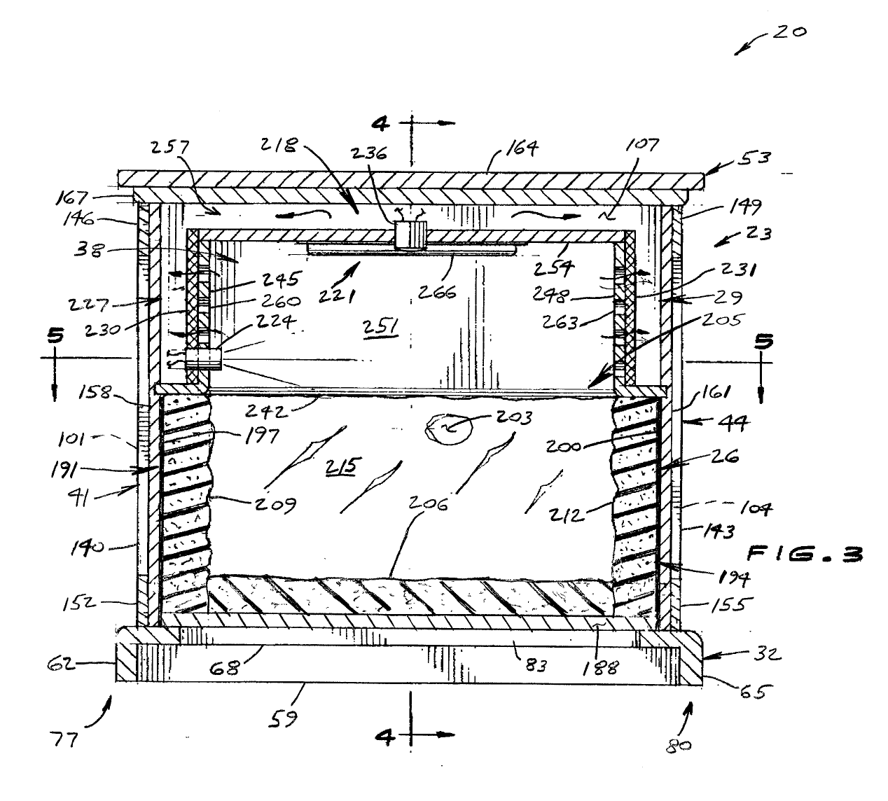

FIG. 4 is substantially a longitudinal vertical sectional view taken on the line 4-4 of FIG. 3 showing the air vents, the filter, the fan, and the flow of air; and

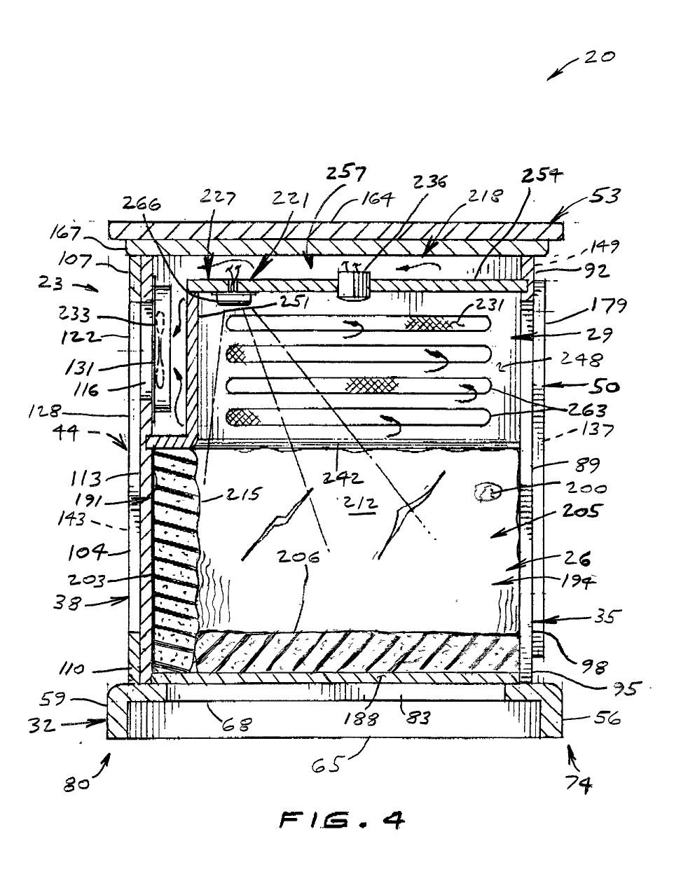

FIG. 5 is substantially a longitudinal horizontal sectional view taken on the line 5-5 of FIG. 3 showing the flow of air.

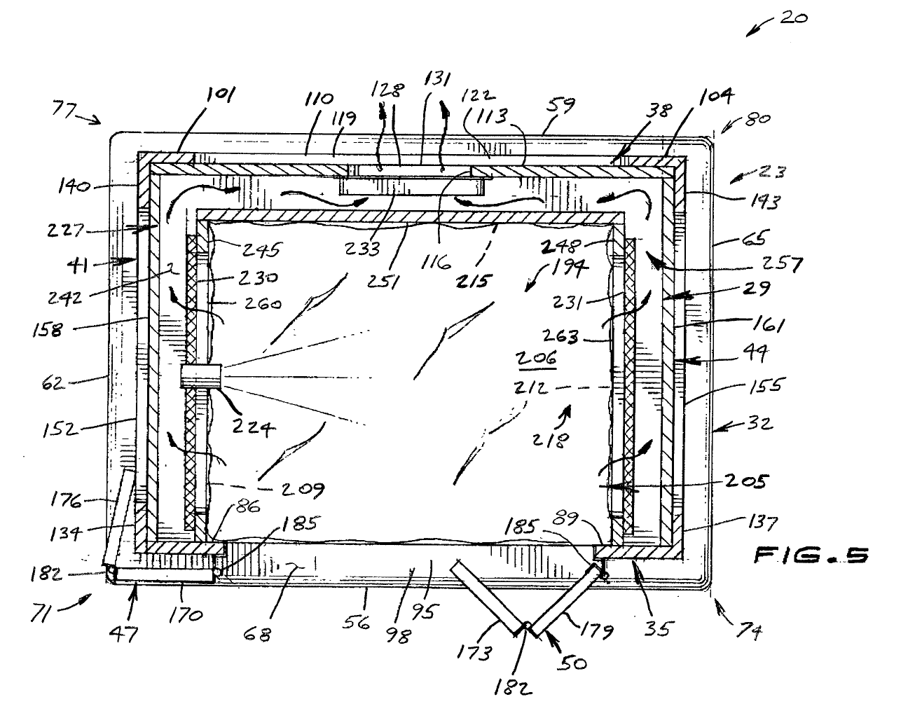

### DESCRIPTION OF THE PREFERRED EMBODIMENT

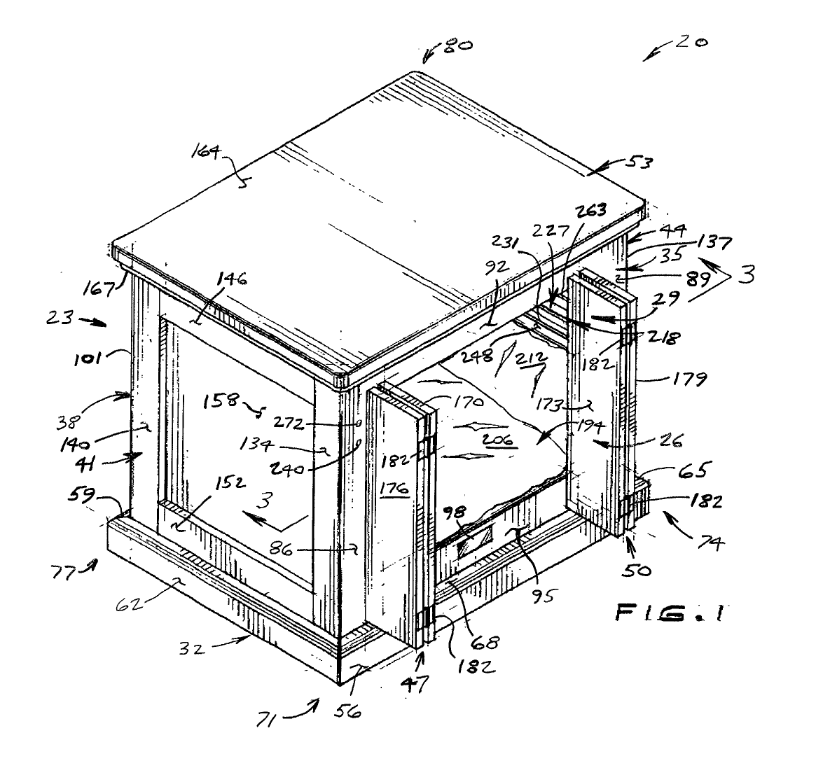

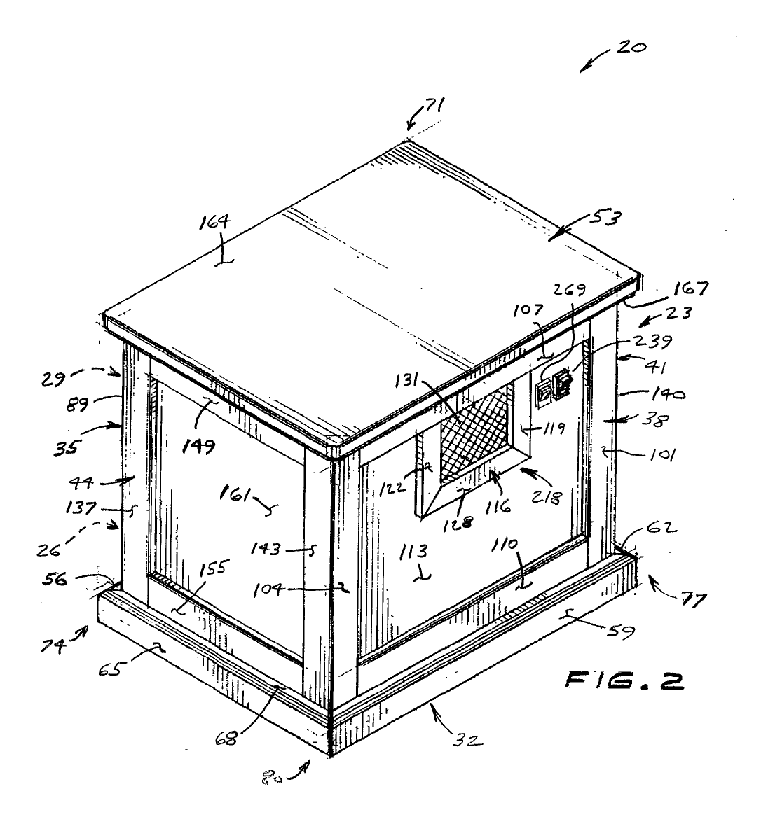

As seen in FIGS. 1 and 2, the present invention comprises a pet enclosure, generally indicated by reference number 20. Pet enclosure 20 comprises a decorative exterior cabinet 23, a lower interior sleeping structure 26, and an upper ventilation structure 29.

Decorative Exterior Wood or Plastic Cabinet

With continuing reference to FIGS. 1 and 2, cabinet 23 includes a base 32, respective front and rear walls 35 and 38, respective left and right side walls 41 and 44, left and right front doors 47 and 50, and a top 53.

Base: A bottom panel such as a base 32 comprises respective front and rear members 56 and 59, respective left and right side members 62 and 65, and a main floor 68. Members 56, 59, 62, and 65 are mitered and glued together at respective left and right front corners 71 and 74, and at respective left and right rear comers 77 and 80 of cabinet 23. Main floor 68 is glued atop members 56, 59, 62, and 65, and includes a rectangular cutout 83 for allowing air to flow therethrough for the purpose explained subsequently.

Walls: Front wall 35 comprises respective left and right upright members 86 and 89 which are glued to main floor 68 adjacent front comers 71 and 74. An upper member 92 and a lower member 95 are glued to upright members 86 and 89, and lower member 95 is glued to main floor 68. Lower member 95 includes an engraving plate 98 such as for the pet's name and the manufacturer of pet enclosure 20.

Rear wall 38 includes respective left and right upright members 101 and 104 which are glued to main floor 68 adjacent rear comers 77 and 80. An upper member 107 and a lower member 110 are glued to upright members 101 and 104 with a center panel 113 glued therebetween, lower member 110 being glued to main floor 68. Center panel 113 has a rectangular ventilation hole 116 therethrough surrounded by respective frame members 119, 122, and 128 glued thereto which frame a ventilation screen 131 at ventilation hole 116.

Left and right side walls 41 and 44 include respective front upright members 134 and 137, respective rear upright members 140 and 143, respective upper members 146 and 149, respective lower members 152 and 155, and respective center panels 158 and 161.

Top: A top panel such as a top 53 comprises an upper panel 164 and an attached lower panel 167 which is hingedly connected to rear wall 38 for access into cabinet 23.

Doors: Left and right front doors 47 and 50 comprise respective inner panels 170 and 173 hingedly connected to respective outer panels 176 and 179 by means of a plurality of infinitely positional hinges, or spring hinges 182 which remain in a ninety degree open or a closed position until moved. Outer panels 176 and 179 are hingedly connected to upright members 86 and 89 by means of a plurality of infinitely positional hinges, or spring hinges 185 which remain in a ninety-degree open position or in a closed position until moved.

Lower Interior Sleeping Structure

Lower interior sleeping structure 26 comprises a cedar floor panel 188, an interior liner 191, and a pad assembly 194.

Cedar Floor Panel: Cedar floor panel 188 comprises a cedar board which is of such size as to sit atop main floor 68 of base 32 above rectangular cutout 83 allowing air to flow against cedar floor panel 188 to repel fleas and ticks from both above and from below. The aromatic odor of the cedar of floor panel 188 provides a pleasing aroma to people while repelling fleas and ticks brought by the dog or cat away from pet enclosure 20. While floor panel 188 can be permanently affixed within pet enclosure 20, allowing floor panel 188 to freely rest on base 32 permitting replacement should the cedar odor wane.

Interior Liner: Interior liner 191 comprises respective left, right, and rear panels 197, 200, and 203, which are adhesively or otherwise affixed within a sleeping chamber 205 respectively to center panels 113, 158, and 161. Liner 191 is made of a light colored plastic such as white polyvinyl chloride for cleanability and to highlight fleas and ticks. Liner 191 can also be removable such as for cleaning purposes.

Pad Assembly: Pad assembly 194 comprises a lower pad 206, respective left and right side pads 209 and 212, and a rear pad 215. Lower member 95 of front wall 35 retains lower pad 206 in position.

Upper Ventilation Structure

Upper ventilation structure 29 comprises a filtering ventilation assembly 218, a light assembly 221, and an internet camera 224.

Filtering Ventilation Assembly: Filtering ventilation assembly 218 comprises a ventilation duct 227, respective left and right filters 230 and 231, an electric fan 233, a motion detector 236, an on/off switch 239, and a light emitting diode (LED) 240. Ventilation duct 227 includes a U-shaped bottom panel 242 affixed to center panel 158 of left side wall 41, center panel 161 of right side wall 44, and center panel 113 of rear wall 38 which supports respective left and right side panels 245 and 248, a rear panel 251, and a top panel 254 such that a ventilation chamber 257 is formed within cabinet 23. Fan 233 is affixed to center panel 113 of rear wall 38 within ventilation chamber 257 to force air therefrom. Filters 230 and 231 are removably connected such as by means of respective pairs of brackets (not shown) to the respective left and right side panels 245 and 248 covering respective pluralities of transverse slots 260 and 263 thereof. Motion detector 236 is disposed through top panel 254 and switch 239 through center panel 113 of rear wall 38 such that when switch 239 is in the “on” position, movement within sleeping chamber 205 of pet enclosure 20 activates fan 233 to draw air from sleeping chamber 205 through filters 230 and 231, through ventilation chamber 257 and out to ambient air with the odor and airborne particulates such as pet dander removed, and LED 240 is illuminated to indicate such.

Light Assembly

Light assembly 221 comprises a light fixture 266, an on/off switch 269, and a light emitting diode (LED) 272. Light fixture 266 is disposed through top panel 254 and switch 269 through center panel 113 of rear wall 38 adjacent switch 239 such that when switch 269 is in the “on” position light fixture 266 illuminates sleeping chamber 205 and LED 272 is illuminated indicating such.

Internet Camera

Internet camera 224 is disposed through left side panel 245 of ventilation duct 227 such that when it is desired to check on the pet's status when the owner is away, the pet can be viewed over the Internet by means of camera 224. Camera 224 can be of the low light variety or used in conjunction with light assembly 221.

Front Grate

A front grate (not shown) can be attached to front wall 35 of exterior cabinet 23 to confine the pet within sleeping chamber 205 while leaving front doors 47 and 50 open for ventilation purposes.

Retrofit and Manufacturer's Packages

Various combinations of the features of the pet enclosure can be sold as packages to manufacturers to incorporate the present invention into their pet enclosures, and sold to owners of existing pet enclosures to “upgrade” their pet enclosures to incorporate the present invention.

Insert Package: An insert package (not shown) retrofits a version of lower sleeping structure 26 to existing pet enclosures, including analogous component parts to cedar floor panel 188, interior liner 191, and a pad assembly 194, but specifically designed to fit the particular pet enclosure, including the associated parts for physical connection thereof.

Filtering Ventilation Package: A filtering ventilation package (not shown) retrofits a filtered ventilation system to existing pet enclosures, including analogous component parts to ventilation duct 227 (though not absolutely necessary if the filter is connected directly to the fan), left and right filters 230 and 231 (though only one filter need be included), electric fan 233, and switch 239, but specifically designed to fit the particular pet enclosure, including the associated parts for physical and electrical connection thereof. Other features of the filtering ventilation package can include analogous parts to motion detector 236, and light emitting diode (LED) 240.

Internet Camera Package: An Internet camera package (not shown) retrofits a filtered ventilation system to existing pet enclosures, including analogous component parts to internet camera 224, but specifically designed to fit the particular pet enclosure, including the associated parts for physical and electrical connection thereof

Light Assembly Package: A light assembly package (not shown) retrofits a light to existing pet enclosures, including analogous component parts to light fixture 266, and on/off switch 269, but specifically designed to fit the particular pet enclosure, including the associated parts for physical and electrical connection thereof Other features of the filtering ventilation package can include analogous parts to a light emitting diode (LED) 272.

### CONCLUSION

It can now be seen that the present invention solves many of the problems associated with the prior art. The present invention provides a pet enclosure which fits in with and compliments the existing furniture in a house or apartment. The present invention further provides a filtering ventilation assembly which reduces pet odor. The present invention further provides adaptability to virtually any style of furniture by providing a modified cabinet. The present invention still further provides a filtering ventilation assembly which reduces human allergies and is healthier for the pet by reducing airborne pet dander. The present invention yet further provides the ability to monitor the pet by camera over the Internet.

Although the description above contains many specifications, these should not be construed as limiting the scope of the invention but as merely providing illustrations of some of presently preferred embodiments of this invention. The specification, for instance, makes reference to pet enclosures such as for dogs and cats. However, the present invention is not intended to be limited to dogs and cats. Rather it is intended that the present invention can be used with any type of pet desired. Likewise, while the enclosure is typically enclosed except for an entrance opening, the present invention can be used with other enclosures which are less enclosed such as by not having a top. While the pet enclosure illustrated is made of wood, the component parts thereof can be made of other materials including plastics such as polyvinyl chloride, polystyrene, and polypropylene. Plastic versions might be roto-molded, injection molded, or cut from sheets. The base, the top panel, and the wails can each be a single piece of plastic with the respective members and panels thereof forming the single piece. The panels can be finished to look like real wood, and removably interlock together using hooks and slots or other such devices. Likewise, while the enclosure is shown with the electric fan, the filters, and the ventilation duct positioned adjacent the top of the exterior cabinet, these can be positioned virtually anywhere desired. They might be positioned adjacent the base, or even connected to the outside of the cabinet. Also, the ventilation duct can be eliminated altogether, wherein a filter is attached to the electric fan so as to draw air directly from the interior of the cabinet, through the filter and fan, and exhausted to ambient air. Thus, the scope of the invention should be determined by the appended claims and their legal equivalents rather than by the examples given.

What is claimed is:

1. An enclosure for housing a pet, comprising a cabinet having a bottom panel and a top panel which are interconnected by at least one upstanding wall to define a generally enclosed sleeping chamber of sufficient size to contain the pet, said upstanding wall having an entrance opening of sufficient size to allow the pet to enter and exit said sleeping chamber.

2. The enclosure of claim 1, further comprising a filtering ventilation assembly which includes an electric fan and at least one filter, said fan and said filter being operatively connected to the cabinet so as to draw airborne particulate laden interior air from within the sleeping chamber through said filter and out to ambient air as filtered air, said filter which removes the airborne particulates from the particulate laden air.

3. The enclosure of claim 2, wherein the filter includes activated carbon to remove odors from the interior air.

4. The enclosure of claim 2, wherein the filtering ventilation assembly further includes a motion detector for automatically activating the electric fan when the pet enters and occupies the sleeping chamber, and an on/off switch for activating and deactivating said filtering ventilation assembly.

5. The enclosure of claim 2, wherein the filtering ventilation assembly further includes a ventilation duct formed in conjunction with the cabinet, said ventilation duct defining a ventilation chamber in fluid contact with the interior air within the sleeping chamber at an air inlet of said ventilation duct, and in fluid contact with the ambient air at an air outlet of said ventilation duct, the filter covering said air inlet and the fan covering said air outlet for drawing interior air from within said sleeping chamber through said filter and said ventilation chamber out to ambient air as filtered air.

6. The enclosure of claim 5, wherein the ventilation duct is of generally U-shape having a base leg at a rear of the cabinet and a pair of dependent legs which each wrap at least a portion of the way around the cabinet toward the front, the fan being connected to said base leg covering the air outlet, the filter covering the air inlet through one of said legs, and a second filter covering a second air inlet through the other of said legs.

7. The enclosure of claim 6, wherein the ventilation duct of the filtering ventilation assembly is disposed within the cabinet at an upper portion thereof.

8. The enclosure of claim 7, further comprising a pad assembly which fits within a lower portion of the cabinet, having a lower pad configured to rests on the bottom panel and at least one upstanding pad which extends for at least a portion of an outside perimeter of said lower pad, said upstanding pad being of such a height as to closely fit below the ventilation duct and of a similar width so as to be generally flush therewith.

9. The enclosure of claim 8, wherein the cabinet is of generally rectangular configuration, the top and bottom panels being of generally rectangular shape, interconnected by generally rectangular front and rear walls, and by a pair of generally rectangular side walls, and wherein the lower pad is generally rectangular and the upstanding pad comprises a pair of opposed side pads and a rear pad, all of generally rectangular shape.

10. The enclosure of claim 1, further comprising a plastic sheet liner of a light color disposable within at least a lower portion of the cabinet closely adjacent the at least one upstanding wall to highlight fleas and ticks and to provide easy cleaning.

11. The enclosure of claim 1, further comprising an insect repellant disposable within the cabinet to repel fleas and ticks.

12. The enclosure of claim 11, wherein the insect repellant comprises a cedar board.

13. The enclosure of claim 12, further comprising a plastic sheet liner of a light color disposable within at least a lower portion of the cabinet closely adjacent the at least one upstanding wall to highlight fleas and ticks and to provide easy cleaning.

14. The enclosure of claim 1, further comprising a camera connectable within the cabinet and which is operably connectable to the Internet for transmitting video images to a remote monitoring location.

15. The enclosure of claim 1, wherein the cabinet is made of wood in a decorative style to generally match the style of other furniture with which it will be used.

16. The enclosure of claim 15, wherein the enclosure is built into such other furniture.

17. The enclosure of claim 15, wherein the cabinet is of generally rectangular configuration, the top and bottom panels being of generally rectangular shape, interconnected by generally rectangular front and rear walls, and by a pair of generally rectangular side walls, and wherein the lower pad is generally rectangular and the upstanding pad comprises a pair of opposed side pads and a rear pad, all of generally rectangular shape.

18. The enclosure of claim 17, further comprising respective left and right double doors hingedly connected to the front wall to selectively cover the entrance opening at the front of the cabinet.

19. The enclosure of claim 18, wherein the left and right double doors comprise respective inner and outer panels which are hingedly connected together using respective pairs of hinges, and wherein said outer panels are hingedly connected to the front wall laterally adjacent the entrance opening using respective pairs of hinges.

20. The enclosure of claim 18, further comprising a grate which is securable to cover the entrance opening.

21. An enclosure for housing a pet, comprising a cabinet having a bottom panel and at least one upstanding wall to define a generally circumferentially enclosed sleeping chamber of sufficient size to contain the pet, said upstanding wall having an entrance opening of sufficient size to allow the pet to enter and exit said sleeping chamber.

22. The enclosure of claim 21, further comprising a filtering ventilation assembly which includes an electric fan and at least one filter, said fan and said filter being operatively connected to the cabinet so as to draw airborne particulate laden interior air from within the sleeping chamber through said filter and out to ambient air as filtered air, said filter which removes the airborne particulates from the particulate laden air.

23. The enclosure of claim 22, wherein the filtering ventilation assembly further includes a motion detector for automatically activating the electric fan when the pet enters and occupies the sleeping chamber, and an on/off switch for activating and deactivating said filtering ventilation assembly.

24. The enclosure of claim 22, wherein the filtering ventilation assembly further includes a ventilation duct formed in conjunction with the cabinet, said ventilation duct defining a ventilation chamber in fluid contact with the interior air within the sleeping chamber at an air inlet of said ventilation duct, and in fluid contact with the ambient air at an air outlet of said ventilation duct, the filter covering said air inlet and the fan covering said air outlet for drawing interior air from within said sleeping chamber through said filter and said ventilation chamber out to ambient air as filtered air.

25. The enclosure of claim 24, further comprising:
a pad assembly which fits within a lower portion of the cabinet, having a lower pad configured to rests on the bottom panel and at least one upstanding pad which extends for at least a portion of an outside perimeter of said lower pad; and
wherein the ventilation duct of the filtering ventilation assembly is disposed within said cabinet at an upper portion thereof, said ventilation duct being of generally U-shape having a base leg at a rear of said cabinet and a pair of dependent legs which each wrap at least a portion of the way around said cabinet toward the front, the fan being connected to said base leg covering the air outlet, the filter covering the air inlet through one of said legs, and a second filter covering a second air inlet through the other of said legs, and wherein said upstanding pad of said pad assembly is of such a height as to closely fit below said ventilation duct and of a similar width so as to be generally flush therewith.

26. The enclosure of claim 21, further comprising a plastic sheet liner of a light color disposable within at least a lower portion of the cabinet closely adjacent the at least one upstanding wall to highlight fleas and ticks and to provide easy cleaning.

27. The enclosure of claim 21, further comprising an insect repellant disposable within the cabinet to repel fleas and ticks.

28. The enclosure of claim 21, further comprising a camera connectable within the cabinet and which is operably connectable to the Internet for transmitting video images to a remote monitoring location.

29. The enclosure of claim 21, wherein the cabinet is made of wood in a decorative style to generally match the style of other furniture with which it will be used.

30. An upgrade package for an enclosure for housing a pet, the enclosure being of the type which includes a cabinet having a bottom panel and at least one upstanding wall to define a generally circumferentially enclosed sleeping chamber of sufficient size to contain the pet, said upstanding wall having an entrance opening of sufficient size to allow the pet to enter and exit said sleeping chamber, the upgrade package comprising at least one upgrade feature chosen from the group consisting of an insert package, a filtering ventilation package, an Internet camera package, and a light assembly package.
